(19) United States
(12) Patent Application Publication
(10) Pub. No.: US 2009/0193990 A1
(43) Pub. Date: Aug. 6, 2009

(54) Seal for an Ink Chamber with Improved Blade/Seal Area

(76) Inventor: Mark E. Van Denend, Paterson, NJ (US)

Correspondence Address: RICHARD M. GOLDBERG, 25 EAST SALEM STREET, SUITE 419, HACKENSACK, NJ, 07601, US

(21) Appl. No.: 12/026,631

(22) Filed: Feb. 6, 2008

(51) Int. Cl. B41F 31/00

(52) U.S. Cl. 101/350.6

(57) ABSTRACT

A seal adapted to seal an end of a fluid chamber which supplies fluid to a roll, includes at least one supporting wall and an upper concave surface on the at least one supporting wall and adapted to engage an outer surface of the roll. First and second, sloping, upper supporting surfaces are formed at opposite ends of the upper concave surface for receiving an end of a doctor/sealing blade thereon. Four flexible, resilient upstanding wings are provided along side edges of the first and second upper supporting surfaces for providing a sealing engagement with the doctor/sealing blades, even when the doctor/sealing blades bow outwardly away from the first and second upper supporting surfaces.

### BACKGROUND OF THE INVENTION

The present invention relates to a sealing assembly for an ink chamber associated with an anilox roll and chamber doctor blade assembly, and more particularly, is directed to a sealing assembly with an improved blade/seal area when the doctor and sealing blades associated therewith bend at their ends.

Conventionally, in printing machines, such as flexographic printing machines, an ink transfer or anilox roll transfers ink to an adjacent plate roll for printing. Ink is supplied to the anilox roll from an ink chamber defined by a chamber housing which partially surrounds the anilox roll. Specifically, ink is supplied through an ink supply tube and then through an ink supply line in the chamber housing, into the ink chamber. In like manner, ink is removed from the ink chamber through an ink return line in the chamber housing and then through an ink return tube.

In order to prevent the escape of ink from the chamber, while ensuring that the ink enters the cells in the anilox roll and has a predetermined volume on the anilox roll, doctor and sealing blades are provided at the exit and entry positions of the anilox roll relative to the ink chamber. The blades are fixed to the chamber housing so that the blades overhang the chamber housing and contact the anilox roll.

With this arrangement, the outer surface of the anilox roll passes through the ink chamber and picks up ink for printing. The ink is metered by means of the doctor blade held to the outlet end of the chamber housing, and sealed with a sealing blade held to the inlet end, with the free ends of the blades being in contact with the outer surface of the anilox roll.

A seal is provided at each end of the blade, that is, at each end of an anilox roll for sealing the ends thereof. Examples of such arrangements are shown in U.S. Pat. Nos. 6,739,248; 6,672,207; 6,598,525; 5,983,797; 5,735,210; 5,662,042; and 5,150,651.

Each seal is formed by a compressible body. Since the seals provided at each end of the anilox roll function to seal the ends of the ink chamber, each seal must lie against the peripheral surface of the rotating anilox roller. As a result, each seal is therefore exposed to mechanical stresses as well as wear. Further, during the printing operation, the blades, which press against the anilox roll, also wear. The geometry of the sealing function between the anilox roll, the two blades and the end seal changes.

Conventionally, each end of a blade sits upon a flat supporting area of the respective seal. As a result, a gap may be created at the opposite ends of the blades where they are held by the chamber seals. However, there is uneven wear on the ends of the blades adjacent the seals, which tends to cause leakage of ink at the ends of the anilox roll. As the doctor blades are forced against the anilox roll and, in particular, when the doctor blades wear unevenly in the sealing area, the sealing and doctor blades may flex or bow outwardly relative to the flat supporting area of the seal. Thus, the areas where the anilox roll, blades and seals join are susceptible to leakage because of geometric changes.

### SUMMARY OF THE INVENTION

Accordingly, it is an object of the present invention to provide a seal for sealing ends of an ink chamber having doctor and sealing blade seals associated therewith, that overcomes the aforementioned problems.

It is another object of the present invention to provide a seal for sealing ends of an ink chamber having doctor and sealing blade seals associated therewith, which ensures a sealing arrangement with the doctor and sealing blades at the ends of the seal, even when even when the doctor and sealing blades bow outwardly away from the downwardly sloping flat supporting surfaces at the ends of the seal.

It is a still further object of the present invention to provide a seal for sealing ends of an ink chamber having doctor and sealing blade seals associated therewith, that is easy to use and economical to manufacture.

In accordance with an aspect of the present invention, a seal adapted to seal an end of a fluid chamber which supplies fluid to a roll, includes at least one supporting wall and an upper concave surface on the at least one supporting wall and adapted to engage an outer surface of the roll. A first upper supporting surface is formed at one end of the upper concave surface for receiving an end of a doctor/sealing blade thereon, and at least one flexible, resilient member is connected with the upper supporting surface for providing a sealing engagement with the doctor/sealing blade, even when the doctor/sealing blade bows outwardly away from the first upper supporting surface.

Preferably, the at least one flexible member includes at least one wing upstanding from the first upper supporting surface.

Generally, there is also a second upper supporting surface at an opposite end of the upper concave surface for receiving an end of another doctor/sealing blade thereon; and at least one the flexible, resilient member connected with the second upper supporting surface for providing a sealing engagement with the other doctor/sealing blade, even when the other doctor/sealing blade bows outwardly away from the second upper supporting surface. In such case, the seal includes four corner sections, and there is one wing at least at two of the corner sections.

Each wing extends along a side edge of the first upper supporting surface at an angle relative to a lengthwise direction of the seal. Preferably, there are at least two wings on opposite sides of the first upper supporting surface which face each other, and inner surfaces of the facing wings have a bowed shape. The bowed shape includes a convex bowed shape from one end to an opposite end of the inner surface of each wing and convex bowed shape from a lower end to an upper end of the inner surface of each wing. An outer surface of each wing is substantially planar such that each wing tapers in thickness from the lower end to the upper end thereof.

The first upper supporting surface slopes down from an inner end thereof to an outer end thereof at an inclined angle relative to a lengthwise direction of the seal, and is formed as a continuation of the upper concave surface.

In accordance with another aspect of the present invention, a seal adapted to seal an end of a fluid chamber which supplies fluid to a roll, includes at least one supporting wall, an upper concave surface on the at least one supporting wall and adapted to engage an outer surface of the roll, and a first upper supporting surface at one end of the upper concave surface for receiving an end of a doctor/sealing blade thereon. The first upper supporting surface has an outwardly bowed shape in an unbiased condition thereof. The first upper supporting surface is also flexible and resilient for providing a sealing engagement with the doctor/sealing blade, even when the doctor/sealing blade bows outwardly away from the first upper supporting surface.

Preferably, there is a second upper supporting surface at an opposite end of the upper concave surface for receiving an end of another doctor/sealing blade thereon. The second upper supporting surface also has an outwardly bowed shape in an unbiased condition thereof. The second upper supporting surface being flexible and resilient for providing a sealing engagement with the other doctor/sealing blade, even when the other doctor/sealing blade bows outwardly away from the second upper supporting surface.

In one embodiment, the entire seal, including the first upper supporting surface, is made from a foam material.

The above and other objects, features and advantages of the invention will become readily apparent from the following detailed description thereof which is to be read in connection with the accompanying drawings.

### BRIEF DESCRIPTION OF THE DRAWINGS

FIG. 1 is a cross-sectional view of a conventional doctor blade seal associated with an anilox roll;

FIG. 1A is a perspective view of the seal of FIG. 1;

FIG. 1B is a cross-sectional view of the conventional doctor blade seal of FIG. 1, showing the doctor blade bending away from the seal;

FIG. 2 is a perspective view of doctor and sealing blade seal according to the present invention;

FIG. 3 is a side elevational view of the doctor and sealing blade seal of FIG. 2;

FIG. 4 is a top plan view of the doctor and sealing blade seal of FIG. 2;

FIG. 5 is a bottom plan view of the doctor and sealing blade seal of FIG. 2;

FIG. 6 is a cross-sectional view of the doctor and sealing blade seal of FIG. 4, taken along line 6-6 thereof;

FIG. 7 is a cross-sectional view of the doctor and sealing blade seal of FIG. 4, taken along line 7-7 thereof;

FIG. 8 is an end elevational view of the doctor and sealing blade seal of FIG. 1; and

FIG. 9 is a cross-sectional view of the doctor and sealing blade seal of FIG. 3, taken along line 9-9 thereof;

FIG. 10 is a perspective view of a doctor and sealing blade seal according to another embodiment of the present invention;

FIG. 11 is a cross-sectional view of the doctor and sealing blade seal of FIG. 10, associated with an anilox roll;

FIG. 12 is a cross-sectional view of the doctor and sealing blade seal of FIG. 11, showing the doctor blade bending away from the seal.

### DETAILED DESCRIPTION

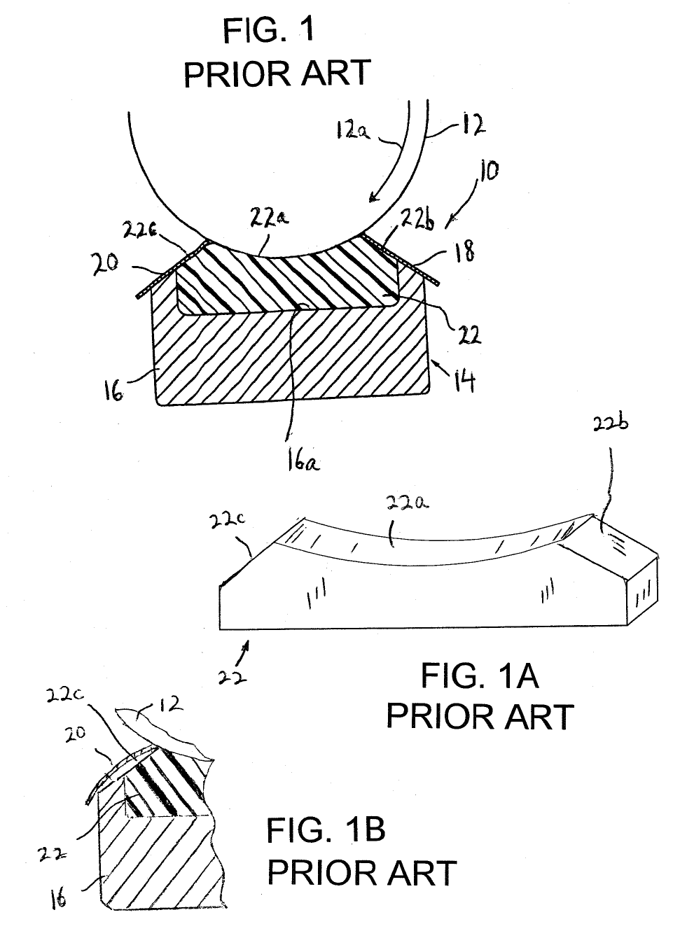

Referring to the drawings in detail, and initially to FIGS. 1, 1A and 1B thereof, there is shown a conventional sealing assembly 10 for doctor and sealing blades. Conventionally, in printing machines, such as flexographic printing machines, an ink transfer or anilox roll 12 transfers ink to an adjacent plate roll (not shown) for printing. Ink is supplied to anilox roll 12 from an ink chamber 14 defined by a chamber housing 16 which is adjacent to and may partially surround anilox roll 12. Anilox roll 12 rotates in the direction of arrow 12a.

In order to prevent the escape of ink from ink chamber 14, while ensuring that the ink enters the cells in anilox roll 12 and has a predetermined volume on anilox roll 12, a sealing blade 18 and doctor blade 20 are provided at the entry and exit positions of anilox roll 12 relative to ink chamber 14. Blades 18 and 20 are fixed to chamber housing 16 by a blade holder (not shown) so that blades 18 and 20 overhang chamber housing 16 and contact anilox roll 12. Blades 18 and 20 are placed at an angle against the periphery of anilox roll 12 and help to define ink chamber 14 which extends along the length of anilox roll 12.

Seals 22 are provided at each end of anilox roll 12 to seal the ends of ink chamber 14. Each seal 22 has an upper concave surface 22a which lies against the peripheral surface of the rotating anilox roll 12. The edges of upper concave surface 22a continue in downwardly sloping flat supporting surfaces 22b and 22c which support blades 18 and 20, respectively.

With this arrangement, the outer surface of anilox roll 12 passes through ink chamber 14 and picks up ink for printing. The ink is metered by means of doctor blade 20 held to the outlet end of chamber housing 16, and sealed with sealing blade 18 held to the inlet end, with the free ends of blades 18 and 20 being in contact with the outer surface of anilox roll 12.

However, each end of blades 18 and 20 sits upon a flat supporting surface 22b or 22c of a respective seal 22. As a result, a gap may be created at the opposite ends of the blades 18 and 20 where they are held by the chamber seal 22. Because there is uneven wear of blades 18 and 20 adjacent seals 22, this tends to cause leakage of ink at the ends of anilox roll 12. In such case, the sealing and doctor blades 18 and 20 may flex or bow outwardly relative to the flat supporting surfaces 22b and 22c of the respective seal 22, as shown in FIG. 1B. Thus, the areas where anilox roll 12, blades 18 and 20 and seals 22 join are susceptible to leakage because of geometric changes.

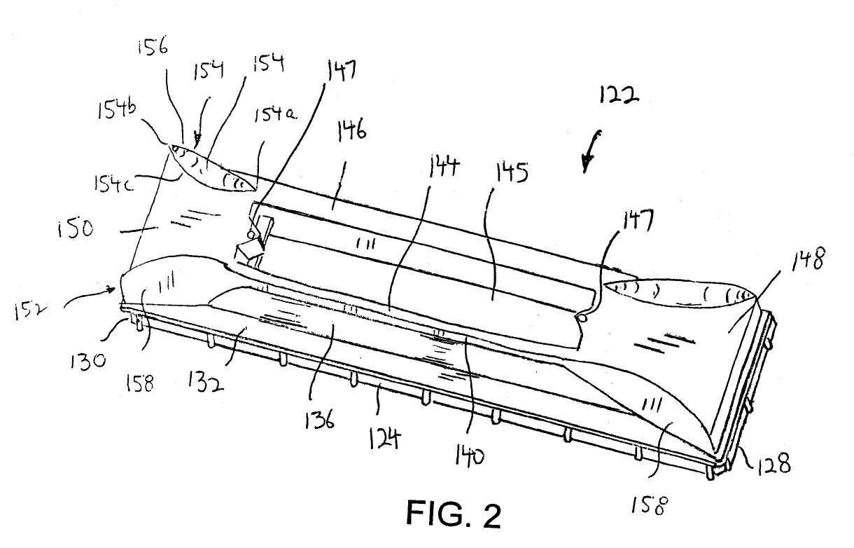

In accordance with the present invention, as shown in FIGS. 2-9, a deformable, compressible, flexible and resilient blade/ink chamber seal 122 for use in a sealing assembly according to the present invention for use with an anilox roll 12 and a sealing blade 18 and doctor blade 20, includes spaced apart side walls 124 and 126 connected together at ends thereof by end walls 128 and 130 to thereby form a substantially rectangular box-like shape.

Ledges 132 and 134 are connected to the upper ends of side walls 124 and 126 and extend inwardly therefrom. Slightly convex walls 136 and 138 extend inwardly and upwardly from the inner edges of ledges 132 and 134, and walls 140 and 142 extend upwardly from the upper, inner edges of convex walls 136 and 138. The upper edges of walls 140 and 142 form upper concave surfaces 144 and 146 which lie against the peripheral surface of the rotating anilox roll 12. The openings 147 in the walls at the opposite ends of this open center area 145 are for providing lubrication in accordance with the teachings of applicant's U.S. patent application Ser. No. 11/502,647, filed Aug. 10, 2006, the entire disclosure of which is incorporated herein by reference, but which does not form part of the present claimed invention.

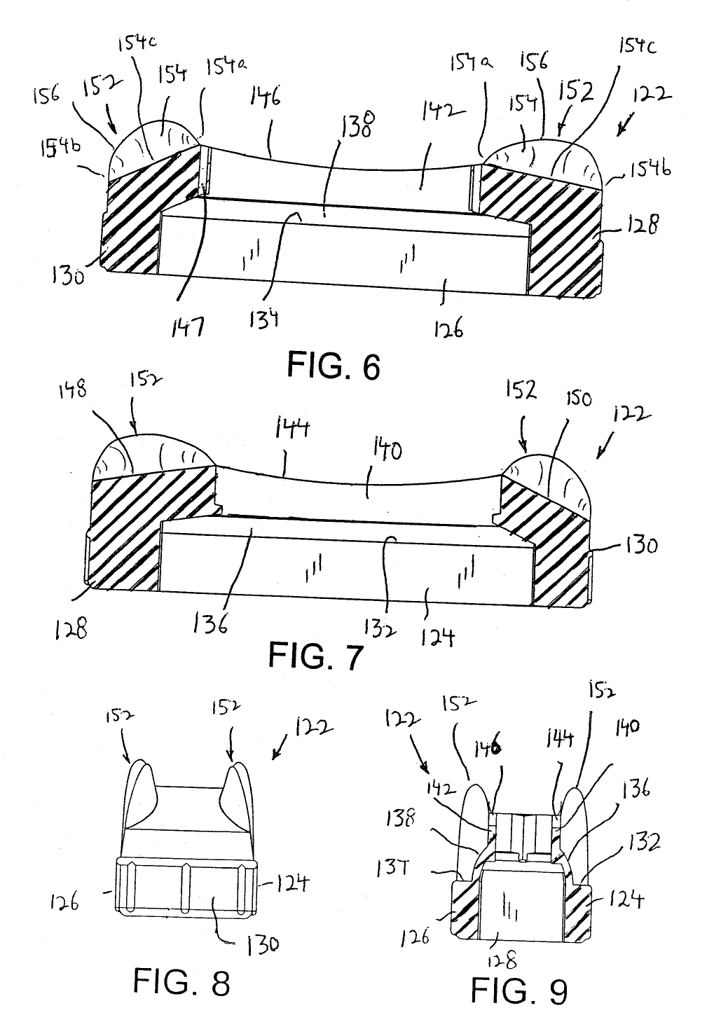

Further, upper concave surfaces 144 and 146 at one end thereof are connected with one end to downwardly sloping flat supporting surface 148, the opposite end of which is connected with the upper end of end wall 128. In like manner, the opposite ends of upper concave surfaces 144 and 146 are connected with one end of downwardly sloping flat supporting surface 150, the opposite end of which is connected with the upper end of end wall 130. The width of downwardly sloping flat supporting surfaces 148 and 150 reduces from the lower ends thereof connected with end walls 128 and 130 to the opposite upper ends connected with upper concave surfaces 144 and 146. Because of the reduction in width of downwardly sloping flat supporting surfaces 148 and 150, it will be appreciated that the side edges thereof are angled relative to the lengthwise dimension of blade/ink chamber seal 122. As shown best in FIGS. 6 and 7, downwardly sloping flat supporting surface 148 has a different slope than downwardly sloping flat supporting surface 150, although the present invention is not limited thereby. Conventionally, downwardly sloping flat supporting surfaces 148 and 150 support blades 18 and 20.

However, as discussed, above, sealing and doctor blades 18 and 20 may flex or bow outwardly relative to downwardly sloping flat supporting surfaces 148 and 150, resulting in leakage thereat.

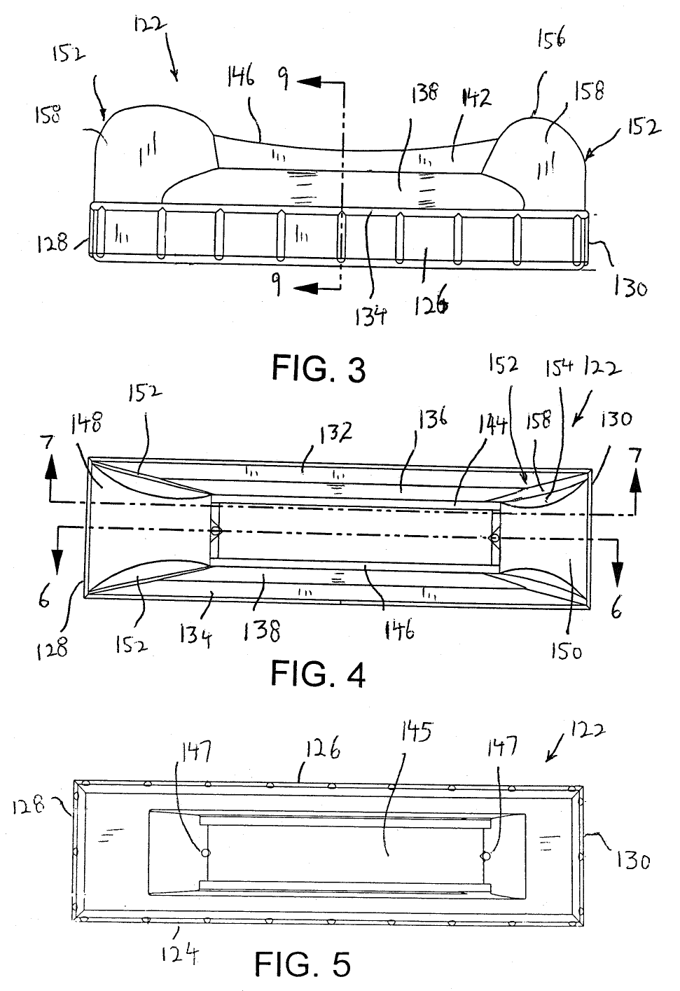

In accordance with the present invention, deformable, flexible and resilient wings 152 are formed at the four corners of blade/ink chamber seal 122. Wings 152 preferably run along the side edges of downwardly sloping flat supporting surfaces 148 and 150 and extend upwardly therefrom. Preferably, inner surfaces 154 of wings 152 which face each other have a curved or bowed shape. Specifically, there is a convex bowed shape from one end 154a to the other end 154b of each inner surface 154. In addition, each inner surface 154 curves outwardly from a bottom 154c thereof where it is connected to the respective downwardly sloping flat supporting surface 148 or 150, to the upper free edge 156 of each wing 152. The outer surface 158 of each wing 152 has a flat or planar shape and is substantially vertically oriented. As a result, the thickness of each wing 152 tapers from its lower connected end to its upper free end 156. Further, as shown best in FIGS. 3 and 6-8, the upper free edge 156 of each wing 152 preferably has a convex shape, although the present invention is not limited thereby.

Because side edges of downwardly sloping flat supporting surfaces 148 and 150 are angled relative to the lengthwise dimension of blade/ink chamber seal 122, wings 152 are also angled by this same amount. For example, wings 152 can be angled at about 15 degrees relative to the lengthwise direction of blade/ink chamber seal 122, as shown in FIG. 4, although the present invention is not limited by this angle.

When blades 18 and 20 are assembled in the sealing assembly, wings 152 are biased down and outwardly, and held down by pressure on blade/ink chamber seal 122. During this initial assembly, because blades 18 and 20 are planar at their ends, the ends of blades 18 and 20 bias and push down wings 152 such that wings 152 are pressed down into a nearly coplanar arrangement relative to downwardly sloping flat supporting surfaces 148 and 150. At this time, blades 18 and 20 are sealed at their ends by engagement with wings 152. In addition, if wings 152 are biased sufficiently so as to be coplanar with downwardly sloping flat supporting surfaces 148 and 150, blades 18 and 20 can also be sealed against downwardly sloping flat supporting surfaces 148 and 150.

However, as sealing and doctor blades 18 and 20 flex or bow outwardly relative to downwardly sloping flat supporting surfaces 148 and 150, due to different pressures at their ends and uneven wear, wings 152, because of their resilience, also move back upwardly with blades 18 and 20. As a result, even if blades 18 and 20 flex or bow outwardly, wings 152 always maintain a sealing engagement therewith, substantially eliminating any leakage thereat caused by such flexing or outward bowing.

It will be appreciated that the present invention is not limited to the above embodiment, but rather, is limited only by the claims herein. For example, the specific construction of blade/ink chamber seal 122 is given by example only, and any other suitable or conventional blade/ink chamber seal can be used, with the wings 152 added thereto.

As another alternative, a plurality of smaller wings 152 can be provided along the side edges of downwardly sloping flat supporting surfaces 148 and 150. Further, wings 152 can be provided inwardly of side edges of downwardly sloping flat supporting surfaces 148 and 150.

Further, although the present invention has been discussed in relation to wings 152 providing the constant sealing contact with blades 18 and 20, it will be appreciated that any member that maintains a seal with the blades 18 and 20 as the blades 18 and 20 bow or flex outwardly can be used. For example, in place of wings 152, a compressed foam material or the like can be used.

Specifically, as shown in FIGS. 10-12, a compressible foam seal 222 according to another embodiment of the present invention, and which is provided at each end of anilox roll 12 to seal the ends of ink chamber 14, has an upper concave surface 222a which lies against the peripheral surface of the rotating anilox roll 12. The edges of upper concave surface 222a continue down at opposite ends thereof in outwardly bowed or convex shaped supporting surfaces 222b and 222c which support blades 18 and 20, respectively.

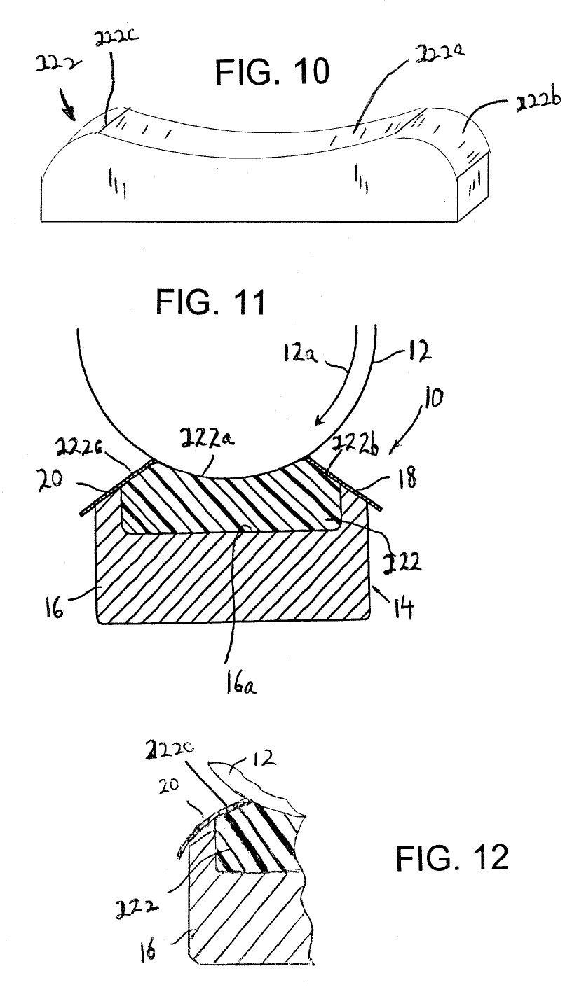

When blades 18 and 20 are assembled therewith, the planar ends of blades 18 and 20 compress convex shaped supporting surfaces 222b and 222c in the manner shown in FIG. 11 so that convex shaped supporting surfaces 222b and 222c are compressed into planar shapes.

Because there is uneven wear of blades 18 and 20 adjacent seals 222, the sealing and doctor blades 18 and 20 may flex or bow outwardly, as discussed above. However, as sealing and doctor blades 18 and 20 flex or bow outwardly, the pressure on convex shaped supporting surfaces 222b and 222c by such ends of blades 18 and 20 is released so that convex shaped supporting surfaces 222b and 222c, due to their resilience, can return back to their convex shape. As a result, convex shaped supporting surfaces 222b and 222c, because of their resilience, also move back upwardly with blades 18 and 20. As a result, even if blades 18 and 20 flex or bow outwardly, convex shaped supporting surfaces 222b and 222c always maintain a sealing engagement therewith, substantially eliminating any leakage thereat caused by such flexing or outward bowing.

Having described a specific preferred embodiment of the invention with reference to the accompanying drawings, it will be appreciated that the present invention is not limited to that precise embodiment and that various changes and modifications can be effected therein by one of ordinary skill in the art without departing from the scope or spirit of the invention as defined by the appended claims.

1. A seal adapted to seal an end of a fluid chamber which supplies fluid to a roll, comprising:
at least one supporting wall,
an upper concave surface on said at least one supporting wall and adapted to engage an outer surface of the roll,
a first upper supporting surface at one end of the upper concave surface, and
at least one flexible, convex, resilient member connected with the upper surface for providing a sealing engagement with a doctor/sealing blade, even when the doctor/sealing blade bows outwardly away from the first upper surface.

2. A seal according to claim 1, wherein said at least one flexible, resilient member includes at least one wing upstanding from said first upper surface.

3. A seal according to claim 1, further comprising:
a second upper surface at an opposite end of the upper concave surface; and
at least one said flexible, convex, resilient member connected with said second upper surface for providing a sealing engagement with another doctor/sealing blade, even when the other doctor/sealing blade bows outwardly away from the second upper surface.

4. A seal according to claim 3, wherein said seal includes four corner sections, and there is one wing at least at two of said corner sections.

5. A seal according to claim 1, wherein said first upper surface slopes down from an inner end thereof to an outer end thereof at an inclined angle relative to a lengthwise direction of said seal.

6. A seal according to claim 1, wherein said first upper surface is formed as a continuation of said upper concave surface.

7. A seal adapted to seal an end of a fluid chamber which supplies fluid to a roll, comprising:
at least one supporting wall,
an upper concave surface on said at least one supporting wall and adapted to engage an outer surface of the roll,
a first upper surface at one end of the upper concave surface for receiving an end of a doctor/sealing blade thereon, said first upper surface having an outwardly bowed shape in an unbiased condition thereof, said first upper surface being flexible and resilient for providing a sealing engagement with the doctor/sealing blade, even when the doctor/sealing blade bows outwardly away from the first upper surface.

8. A seal according to claim 7, further comprising:
a second upper surface at an opposite end of the upper concave surface for receiving an end of another doctor/sealing blade thereon, said second upper surface having an outwardly bowed shape in an unbiased condition thereof, said second upper surface being flexible and resilient for providing a sealing engagement with the other doctor/sealing blade, even when the other doctor/sealing blade bows outwardly away from the second upper surface.

9. A seal according to claim 7, wherein said first upper surface is made from a foam material.

10. A seal according to claim 7, wherein the entire seal, including said first upper surface, is made from a foam material.
